(19) United States
(12) Patent Application Publication
(10) Pub. No.: US 2011/0102896 A1
(43) Pub. Date: May 5, 2011

(54) FOREIGN SUBSTANCE REMOVING APPARATUS

(75) Inventor: Kaishi Ohashi, Tokyo (JP)

(73) Assignee: CANON KABUSHIKI KAISHA, Tokyo (JP)

(21) Appl. No.: 12/910,996

(22) Filed: Oct. 25, 2010

(30) Foreign Application Priority Data
Oct. 30, 2009 (JP) 2009-249897

(51) Int. Cl. G02B 27/00

(52) U.S. Cl. 359/507

(57) ABSTRACT

Provided is a foreign substance removing apparatus including: an optical element disposed on a light incident side of an image pickup element; an electro-mechanical energy converting element disposed on the optical element; and a drive circuit for applying an electric signal to the electro-mechanical energy converting element, the foreign substance removing apparatus generating an elastic vibration in the optical element through application of the electric signal to the electro-mechanical energy converting element by the drive circuit, to thereby remove or move a foreign substance adhering to a surface of the optical element by the elastic vibration, in which the drive circuit applies a voltage corresponding to the electric signal with a period which is a natural nember multiple of a natural period of the elastic vibration, to the electro-mechanical energy converting element.

### BACKGROUND OF THE INVENTION

1. Field of the Invention

The present invention relates to a foreign substance removing apparatus (also referred to as “dust cleaning device”), and more particularly, to a foreign substance removing apparatus for use in an optical device, such as a camera, a facsimile machine, a scanner, a projector, a copying machine, a laser beam printer, an ink jet printer, a lens, binoculars, or an image display apparatus.

2. Description of the Related Art

In recent years, an image pickup device such as a camera, a copying machine, or a scanner has been improved in resolution of an optical sensor. Along with the improvement, an image taken by the image pickup device has become more seriously affected by dust that adheres to an optical system during use.

In particular, the resolution of an image pickup element of a digital camcorder or a still camera is remarkably improving. Accordingly, if dust adheres to an optical element disposed close to the image pickup element, a defect may be caused in the image.

For example, if dust such as dust from outside or abrasion powder generated on an internal mechanical sliding friction surface adheres to an optical element such as an infrared cut filter or an optical low-pass filter, the dust comes out in the taken image all the more for the small amount of blurring of the image on a surface of the image pickup element, leading to impairment of image quality.

In view of the above, there has been hitherto proposed a foreign substance removing apparatus in which vibrations are applied to an optical element so as to shake off dust by an inertial force, to thereby remove the dust (Japanese Patent Application Laid-Open No. 2007-267189).

However, the above-mentioned conventional foreign substance removing apparatus has a problem as follows. In the foreign substance removing apparatus disclosed in Japanese Patent Application Laid-Open No. 2007-267189, as illustrated in FIG. 4A, a piezoelectric element is coupled to an optical element, to thereby form a vibrator.

FIG. 4B illustrates out-of-plane displacement distributions of two vibrations excited in the vibrator and in the optical element of the foreign substance removing apparatus of FIG. 4A.

The two vibrations are out-of-plane bending vibrations, and are different from each other by one in terms of an order of vibration.

An electric signal with a period which substantially coincides with a natural period of each of the two vibrations is generated in a drive circuit, and the electric signal is applied to the piezoelectric element.

In this manner, a period of a deformation force of the piezoelectric element substantially coincides with the natural period of the vibrator, which causes a resonance phenomenon to occur in the vibrator.

The vibration magnified by the resonance phenomenon is excited in the vibrator, to thereby obtain a large vibration of the optical element. The vibration generates an inertial force, which shakes off dust for removal.

The inertial force is proportional to the acceleration of the vibration, and the acceleration is proportional to the second power of the inverse of the period.

In order to attain a large inertial force so as to enhance dust removal performance, a vibration with a short natural period needs to be excited. In this case, a drive circuit for generating an electric signal of short period needs to be employed.

Such a drive circuit requires a switching element having a short switching period, which leads to problems such as a large loss of power, an increase in cost, and an increase in footprint.

### SUMMARY OF THE INVENTION

The present invention has been accomplished in view of the above-mentioned problems, and therefore, it is an object of the invention to provide a foreign substance removing apparatus capable of exciting a large vibration with a simple drive circuit, to thereby improve dust removal performance.

The present invention provides a foreign substance removing apparatus configured as follows.

A foreign substance removing apparatus according to the present invention, includes:

an optical element disposed on a light incident side of an image pickup element;

a vibrator including the optical element and an electro-mechanical energy converting element disposed on the optical element; and

a drive circuit for applying an electric signal to the electro-mechanical energy converting element,

the foreign substance removing apparatus exciting a vibration in the vibrator through application of the electric signal to the electro-mechanical energy converting element by the drive circuit, to thereby remove or move a foreign substance adhering to a surface of the optical element by the vibration excited in the vibrator,

in which the drive circuit applies a voltage corresponding to the electric signal with a period which is a natural nember multiple of a natural period of the vibration, to the electro-mechanical energy converting element.

According to the present invention, there may be obtained a foreign substance removing apparatus capable of obtaining a large vibration with a simple drive circuit by exciting a vibration of short natural period with a long-period electric signal, to thereby improve dust removal performance.

Further features of the present invention will become apparent from the following description of exemplary embodiments with reference to the attached drawings.

### BRIEF DESCRIPTION OF THE DRAWINGS

FIG. 1 is a perspective view of a foreign substance removing apparatus according to an embodiment of the present invention.

FIG. 2 illustrates a relation between a configuration of a vibrator and vibrations to be excited therefrom, according to an embodiment of the present invention.

FIG. 3 is a graph showing a waveform of an electric signal according to an embodiment of the present invention.

FIGS. 4A and 4B each illustrate a conventional example, FIG. 4A illustrating a configuration of a conventional foreign substance removing apparatus, FIG. 4B illustrating shapes of vibrations excited in a vibrating mode by the foreign substance removing apparatus of FIG. 4A.

### DESCRIPTION OF THE EMBODIMENT

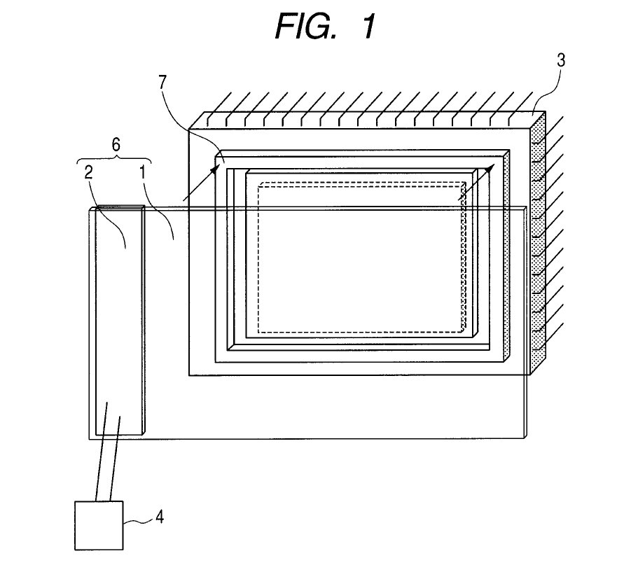

Next, with reference to FIG. 1, a foreign substance removing apparatus according to an embodiment of the present invention for removing or moving a foreign substance adhering to a surface of an optical element is described.

In FIG. 1, a piezoelectric element 2 serving as an electro-mechanical energy converting element is fixed on an optical element 1, on the same side as an image pickup element 3 by adhesion.

The piezoelectric element 2 is in the form of a rectangular plate, and disposed in the vicinity of an end portion on one side of the optical element 1 in the lateral direction.

A drive circuit 4 for generating an electric signal is electrically connected to the piezoelectric element 2. Further, the optical element 1 and the piezoelectric element 2 form a vibrator 6.

The vibrator 6 is attached to the image pickup element 3 serving as a light-receiving element, through a sealing resin 7, so that a space in a surface of the image pickup element 3 is hermetically sealed.

Light from a subject passes through the optical element 1 disposed on a light incident side of the image pickup element 3, and enters the image pickup element 3.

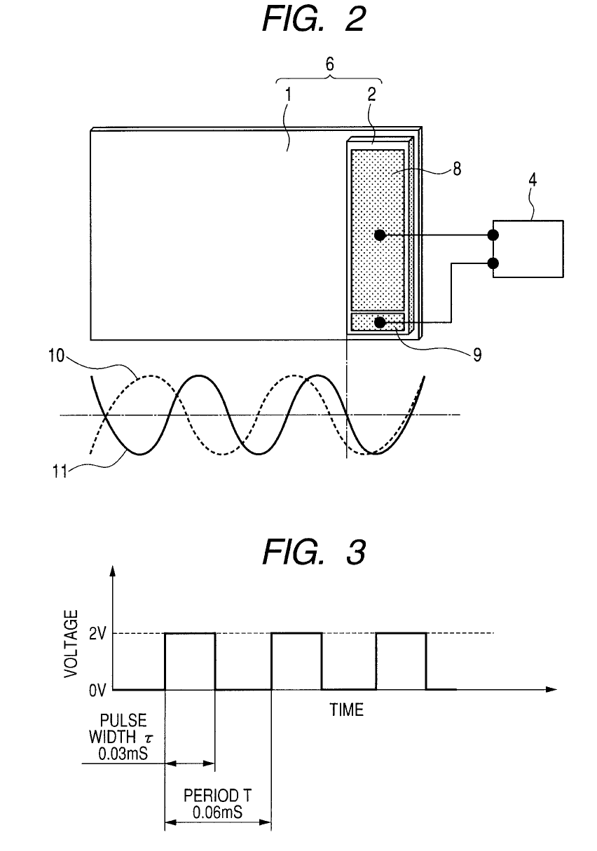

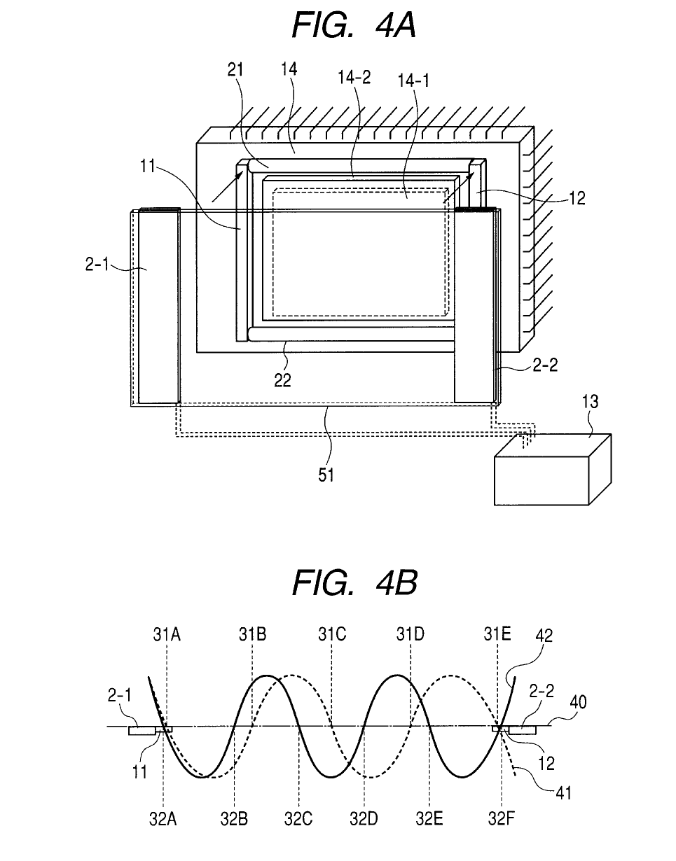

FIG. 2 illustrates a relation between the configuration of the vibrator 6 and vibrations to be excited therefrom, which is a perspective view from the image pickup element 3 side.

The piezoelectric element 2 has a ground electrode (not shown) provided on an entire bonding surface across which the piezoelectric element 2 is fixed to the optical element 1, and also provided with a ground electrode 9 disposed on a part of a surface on the opposite side.

The ground electrode (not shown) and the ground electrode 9 are electrically connected to each other through a via electrode (also called through electrode) passing through the piezoelectric element 2, and further wired to a ground terminal of the drive circuit 4.

A voltage application electrode 8 is provided for the most part of the surface of the piezoelectric element 2, which is wired to a voltage application terminal of the drive circuit 4. The electric signal generated in the drive circuit 4 is configured to be applied to the piezoelectric element 2.

FIG. 2 illustrates out-of-plane displacement distributions in the lateral direction of two bending vibrations 10 and 11 excited in the vibrator 6.

The bending vibration 10 is an out-of-plane fourth order bending vibration with a natural period of 0.02 mS, while the bending vibration 11 is an out-of-plane fifth order bending vibration with a natural period of 0.012 mS.

The piezoelectric element 2 is disposed in a range in which the bending direction of the out-of-plane fourth order bending vibration 10 is the same (bending direction in a lower convex in FIG. 2).

Similarly, the piezoelectric element 2 is disposed in a range in which the bending direction of the out-of-plane fifth order bending vibration 11 is the same.

When a voltage of period to be described later is generated in the drive circuit 4, bending deformation is caused in the piezoelectric element 2, and hence the out-of-plane fourth order bending vibration 10 and the out-of-plane fifth order bending vibration 11 are both excited.

The vibrations 10 and 11 are combined to generate a combined vibration, which is excited in the vibrator 6 and in the optical element 1.

When the vibrations to be combined have nodal lines close to each other in position, both of the vibrations are small at the position, with the result that the combined vibration to be generated becomes small.

The nodal line according to the present invention is formed as follows. That is, when a vibration is applied to a predetermined surface of an object to be vibrated (for example, optical element) so that a standing wave is generated on the surface of the object to be vibrated, a line connecting nodes of the standing wave is referred to as nodal line.

However, in this embodiment, the two vibrations (out-of-plane fourth order bending vibration 10 and out-of-plane fifth order bending vibration 11), which have nodal lines aligned in the same direction, are excited, which are different from each other by one in terms of the order of vibration. In particular, in the center of the optical element 1 in the lateral direction, the nodal lines of the vibrations 10 and 11 are aligned at substantially equal intervals.

Accordingly, a larger vibration is caused particularly in the center of the optical element 1. As a result, high dust removal performance is attained.

FIG. 3 is a graph showing a waveform of the electric signal generated in the drive circuit 4. The abscissa indicates time, and the ordinate indicates voltage.

A waveform E of the electric signal has a rectangular waveform, in which a voltage value takes two values of 0 V and 2 V, a period T is 0.06 mS, a pulse width τ is 0.03 mS, and the duty of application is 50%. When the waveform E is subjected to Fourier series expansion, the waveform E is expanded into a direct current (DC) component, a fundamental wave component with a period of T, and harmonic components including a third harmonic component (or triple harmonic component) with a period of T/3 and a fifth harmonic component with a period of T/5, as expressed in Expression 1 below in which the waveform of the electric signal is subjected to Fourier series expansion.

$$E = 1 + \frac{4}{π} ( \begin{matrix}COS \frac{2 π}{T} t + \frac{1}{3} COS \frac{2 π}{3 T} t + \\ \frac{1}{5} COS \frac{2 π}{5 T} t + \frac{1}{7} COS \frac{2 π}{7 T} t + …\end{matrix} ) \qquad Expression 1$$

In this embodiment, the period T is 0.06 mS, and hence the period of the third harmonic component is 0.02 mS while the period of the fifth harmonic component is 0.012 mS.

The period of the third harmonic component coincides with the natural period of the out-of-plane fourth order bending vibration 10, and the period of the fifth harmonic component coincides with the natural period of the out-of-plane fifth order bending vibration 11.

In this manner, the two vibrations are magnified into a large vibration through a resonance phenomenon, which may be excited in the vibrator 6 and in the optical element 1. A large vibration may be excited by an electric signal having a longer period than the period of the vibration to be excited.

In this embodiment, the period T of the electric signal is set to a natural nember multiple of both of the natural periods of the two vibrations, so that higher dust removal performance may be attained.

However, the period T may not necessarily be a complete natural nember multiple. Even when the period T is a near natural nember multiple, the period of the harmonic component of the electric signal still substantially coincides with the natural period of the vibrator 6, and hence a resonance phenomenon may be excited, to thereby obtain a large vibration from the two vibrations.

Accordingly, the term “natural nember multiple” according to the present invention may also refer to “near natural nember multiple” which may not be equal to the “natural nember multiple” in a strict sense.

Further, the “near natural nember multiple” according to the present invention includes a value capable of attaining a case where “the period of the harmonic component of the electric signal still substantially coincides with the natural period of the vibrator 6, and hence a resonance phenomenon may be excited, to thereby obtain a large vibration from the two vibrations”, which may preferably fall within a numerical range deviated from a positive integer by 10% or less, and more preferably, by 5% or less. Further, even in a case of exciting a single vibration, the period of the electric signal may be set to a near integer multiple of the natural period of the vibration to be excited, so that a large vibration may be similarly excited by a long-period electric signal.

In this embodiment, the duty of application of the electric signal is set to 50%, and hence only the odd numbered harmonics are included in the harmonic component. However, when the duty of application is smaller than 50%, the even numbered harmonics may also be included in the harmonic component.

In this manner, a vibration with a natural period which substantially coincides with an even multiple of the period of the electric signal may be excited into a large vibration.

Further, in this embodiment, the waveform of the electric signal has a rectangular waveform. The rectangular waveform may be formed by switching a direct current (DC) voltage by a switching element, which is advantageous in that a circuit for generating the waveform is simple.

However, according to the present invention, the waveform of the electric signal is not limited to the rectangular waveform. Even when the electric signal has a near rectangular waveform, substantially the same effect may be obtained.

Alternatively, for example, even when the electric signal has any other waveform having a harmonic component, such as a triangle waveform or a sawtooth waveform, a large vibration with a short natural period may be similarly excited by a long-period electric signal.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-249897, filed Oct. 30, 2009, which is hereby incorporated by reference herein in its entirety.

What is claimed is:

1. A foreign substance removing apparatus, comprising:
an optical element disposed on a light incident side of an image pickup element;
a vibrator including the optical element and an electro-mechanical energy converting element disposed on the optical element; and
a drive circuit for applying an electric signal to the electro-mechanical energy converting element,
the foreign substance removing apparatus exciting a vibration in the vibrator through application of the electric signal to the electro-mechanical energy converting element by the drive circuit, to thereby remove or move a foreign substance adhering to a surface of the optical element by the vibration excited in the vibrator,
wherein the drive circuit applies a voltage corresponding to the electric signal with a period which is a natural nember multiple of a natural period of the vibration, to the electro-mechanical energy converting element.

2. The foreign substance removing apparatus according to claim 1, wherein the drive circuit applies a voltage to the electro-mechanical energy converting element, the voltage having a period which is a natural nember multiple of each of natural periods of two vibrations.

3. The foreign substance removing apparatus according to claim 2, wherein the two vibrations have nodal lines aligned in the same direction and are different from each other by one in terms of an order of vibration.

4. The foreign substance removing apparatus according to claim 1, wherein the electric signal has a waveform that includes a harmonic component.

5. The foreign substance removing apparatus according to claim 4, wherein the electric signal has a waveform that is a rectangular waveform.
